(19) United States
(12) Patent Application Publication
(10) Pub. No.: US 2016/0218411 A1
(43) Pub. Date: Jul. 28, 2016

(54) FLEXIBLE ANTENNA TILT INDICATOR

(71) Applicant: CommScope Technologies LLC, Hickory, NC (US)

(72) Inventors: Junfeng YU, Suzhou (CN); Honghui CHEN, Suzhou (CN); Haidan TANG, Suzhou (CN); Zhaohui LIU, Suzhou (CN); Jonathon C. VEIHL, New Lenox, IL (US)

(21) Appl. No.: 14/825,430

(22) Filed: Aug. 13, 2015

Related U.S. Application Data
(60) Provisional application No. 62/108,702, filed on Jan. 28, 2015.

(51) Int. Cl. H01Q 1/00; G01C 9/02; H01Q 3/32

(52) U.S. Cl. CPC H01Q 1/00; H01Q 3/32; G01C 9/02

(57) ABSTRACT

A tilt indicator constructed from a flexible material allows the tilt indicator to bend without breaking when subjected to bending loads. The tilt indicator may take the form of an elongated rod with indicia imprinted thereon. The indicia may be indicative of the degree of tilt of an antenna to which the tilt indicator is attached.

### CROSS-REFERENCE TO RELATED APPLICATIONS

This application claims the benefit of U.S. Provisional Patent Application No. 62/108,702, filed on Jan. 28, 2015, the contents of which are incorporated herein by reference in their entirety.

### BACKGROUND

Various aspects of the present disclosure relate to antennas, and, more particularly, to a tilt indicator mechanism for indicating an angle of tilt of an antennas.

Based on network coverage requirements, operators often adjust a radiation pattern of an antenna. When required, alteration of the vertical angle of the antenna's beam, also known as “tilt”, may be used to adjust the coverage area of the antenna. Adjusting an antenna's angle of tilt has been implemented both mechanically and electrically, either individually or in combination. To advisably show the effect of the adjustment, the antenna may be equipped with a tilt indicator. For example, a tilt indicator may take the form of an indicator rod with markings displayed thereon, to provide a visual indication of the tilt adjustment setting to an individual (e.g., technician, operation, etc.,) making the tilt adjustment. The attached markings may be indicative of tilt degree settings associated with the propagation direction of a beam produced by the antenna.

Unfortunately, conventional construction and placement of the tilt indicator may make the tilt indicator susceptible to damage. For example, to be visible to those operating on the antenna, the tilt indicator may be positioned at least partially outside an enclosure of the antenna. Also, the tilt indicator may be typically constructed of a rigid plastic material, causing the rod to be easily damaged when the antenna may be placed in certain positions, and when subjected to bending loads.

Accordingly, there is a need for a tilt indicator made of flexible material so as to allow the tilt indicator to bend without breaking when subjected to bending loads.

### SUMMARY OF THE DISCLOSURE

Various aspects of the present disclosure may be directed to an antenna tilt indicator constructed from a flexible material so as to allow the tilt indicator to bend without breaking when subjected to bending loads. The tilt indicator may take the form of an elongated rod with indicia imprinted thereon. The indicia may be indicative of the degree of tilt of an antenna to which the tilt indicator may be attached. In some embodiments, the indicia may be imprinted by laser markings directly on a surface of the tilt indicator.

### BRIEF DESCRIPTION OF THE SEVERAL VIEWS OF THE DRAWINGS

The following detailed description of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a side view of a base station antenna with various components attached thereto;

FIG. 2 is a perspective view of a bottom portion of the base station antenna including a flexible tilt indicator according to an aspect of the present disclosure;

FIG. 3 is an example of the flexible tilt indicator being subjected to bending, according to an aspect of the present disclosure;

FIG. 4 is an enlarged view of the flexible tilt indicator according to an aspect of the present disclosure;

FIG. 5 is a plan view of the flexible tilt indicator according to an aspect of the present disclosure;

FIG. 6 is a side view of the flexible tilt indicator according to an aspect of the present disclosure; and

FIG. 7 is a view of the tilt indicator in the base station antenna with the enclosure removed according to an aspect of the present disclosure.

### DETAILED DESCRIPTION OF VARIOUS EMBODIMENTS

Certain terminology is used in the following description for convenience only and is not limiting. The words “lower,” “bottom,” “upper” and “top” designate directions in the drawings to which reference is made. Unless specifically set forth herein, the terms “a,” “an” and “the” are not limited to one element, but instead should be read as meaning “at least one.” The terminology includes the words noted above, derivatives thereof and words of similar import. It should also be understood that the terms “about,” “approximately,” “generally,” “substantially” and like terms, used herein when referring to a dimension or characteristic of a component of the invention, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

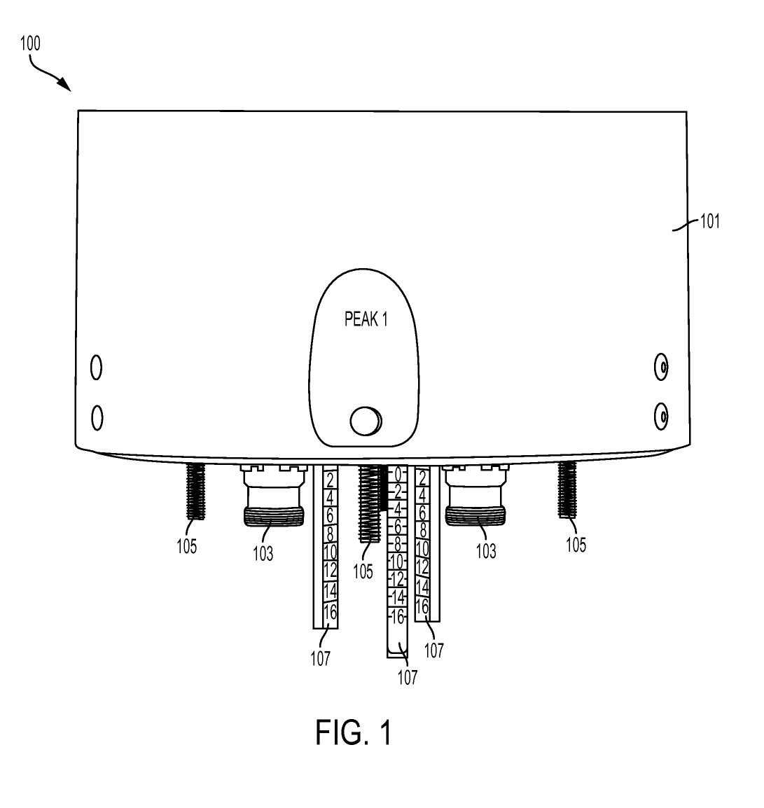

Conventional construction and placement of a tilt indicator makes it susceptible to damage. For example, to be visible to those operating on the antenna, the tilt indicator may be positioned at least partially outside an enclosure of the antenna. Also, the tilt indicator may be typically constructed of a rigid plastic material, such as Acrylonitrile Styrene Acrylate (ASA), causing the tilt indicator to be easily damaged when the antenna may be placed in certain positions, and when subjected to bending loads. For example, referring to FIG. 1, a side view of a base station antenna 100 housed by an enclosure 101 (such as a radome) is depicted. Various components may be attached to a bottom portion of the base station antenna 100. Such components include electrical connectors 103, mounting studs 105, and tilt indicators 107. As shown, the tilt indicators 107 may be extended longitudinally beyond other components (such as the mounting studs 105) attached to a bottom portion of the base station antenna 100. When placed in certain positions, one or more of the tilt indicators 107 may become damaged. For example, when an individual (e.g., a customer, operation, technician, and the like) attempts to rest or mount the end of the base station antenna 100 on a surface on its mounting studs, the one or more tilt indicators 107 (constructed from a rigid material) may break due to contact with the surface, or bending load. As such, aspects of the present disclosure may be directed to a tilt indicator mechanism constructed from a flexible material so as to allow the tilt indicator to bend without breaking when subjected to such bending loads.

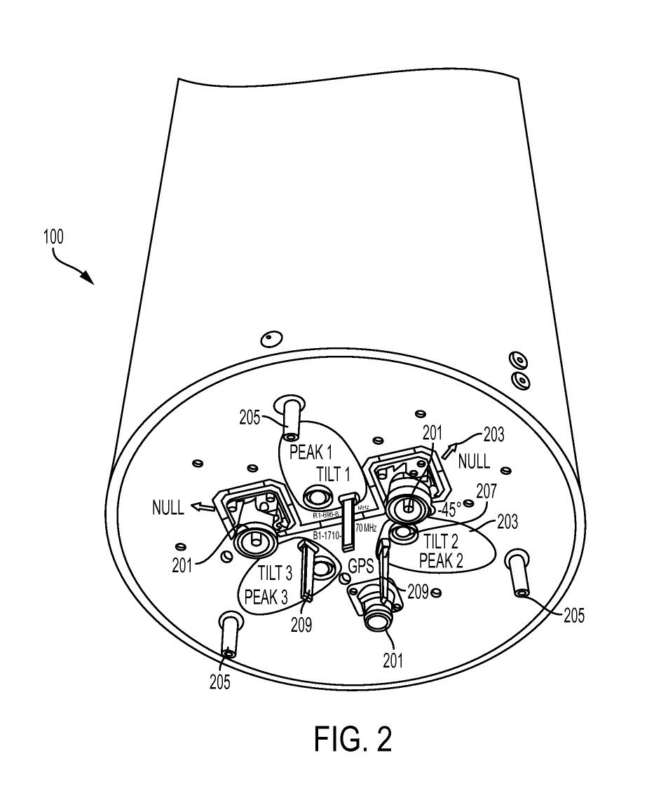

Referring now to FIG. 2, a perspective view of a bottom portion of a base station antenna 100 is depicted. As shown, connected to the bottom portion of the base station antenna 100 may include various components including RF connectors 201, null and peak indicators 203, mounting studs 205, downtilt adjuster members 207, and flexible tilt indicator(s) 209 according to an aspect of the present disclosure. One end of the flexible tilt indicator 209 may be coupled to one or more phase shifter mechanisms, for example, via a drive shaft or connecting member so as to move, for example, linearly, with the drive shaft or connecting member. Based on such movement, a certain portion (e.g., length) of the flexible tilt indicator 209 may extend out of the bottom portion of the antenna 100 visibly indicating (via the attached indicia associated with the exposed portion of the flexible tilt indicator) a tilt angle of the base station antenna 100. Even though a base station antenna 100 is depicted in FIG. 2, aspects of the present disclosure may be applied to other types of antennas as well, having other components (e.g., in addition to, or in lieu of, the above discussed RF connectors 201, null and peak indicators 203, mounting studs 205, and downtilt adjuster members 207, etc.) attached thereto. For example, the flexible tilt indicator 209 may be coupled to any antenna 100 capable of being tilted. Further, based, at least in part, on the type of antenna, one, or more than one, flexible tilt indicator 209 may be employed according to aspects of the present disclosure. For example, in the instance of an antenna 100 capable of supporting more than one frequency band, more than one flexible tilt indicator 209 may be employed to visibly indicate a tilt of each supported frequency band of the base station antenna 200.

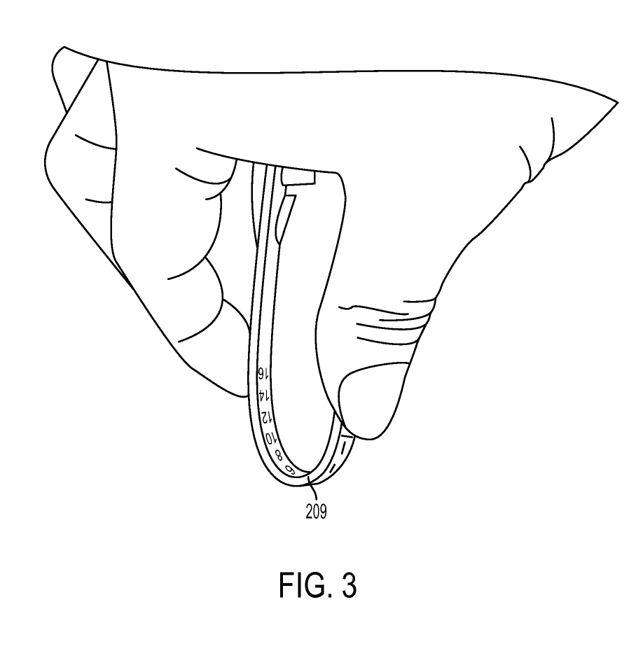

The flexible tilt indicator 209 may be constructed from a flexible material, such as thermoplastic Polyolefin Elastomer (TEO), manufactured by RTP Co. headquartered in Winona, Minn. 55987 USA. Further, according to an aspect of present disclosure, the flexible tilt indicator 209 may be constructed by injection molding. As used herein, injection molding may refer to a process wherein a material may be formed into a shape by forcing the material into a mold or die by fluidizing the material and injecting the fluidized material into the mold by applying a pressure to the fluidized material. The flexible tilt indicator 209 may take the form of an elongated rod, or any other shape capable of visibly indicating a degree of tilt of an antenna 100. It should be noted that the flexible tilt indicator 209 may be constructed from other material as well. For example, the flexible tilt indicator 209 may be constructed from any flexible material in keeping with the spirit of the disclosure. It should also be noted that the flexible tilt indicator 209 may be created via other processes besides injection molding in keeping with the spirit of the disclosure. Being constructed of such a resilient material, the flexible tilt indicator 209 may be capable of bending without breaking when subjected to bending loads, and subsequently return to its original shape. An example of the flexible tilt indicator 209 being subjected to bending without damage is shown in FIG. 3.

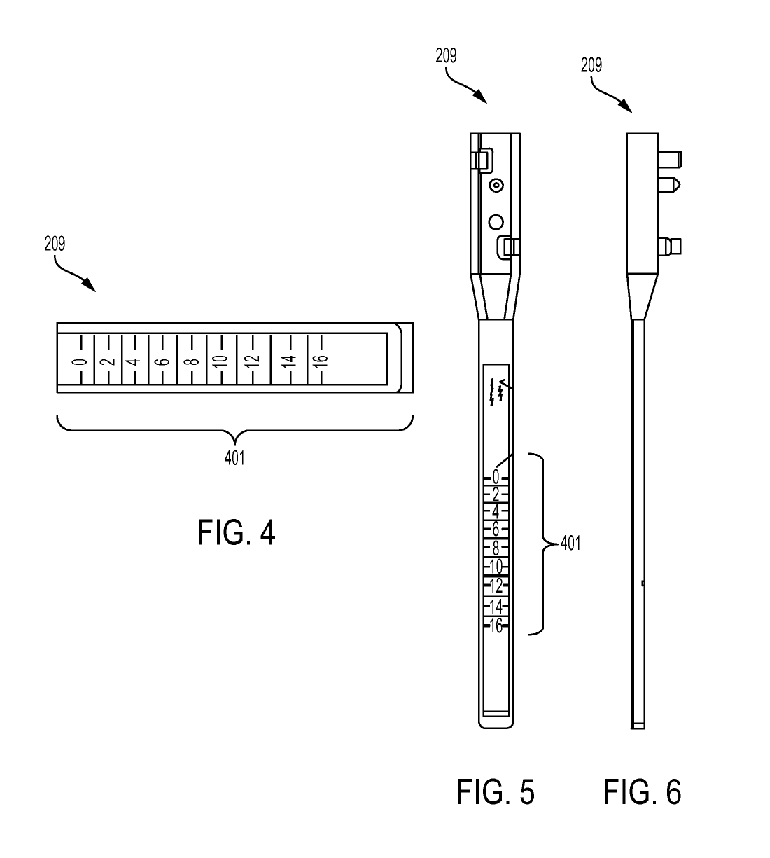

To address such label damage, according to an aspect of the present disclosure, instead of attaching a label, a surface of the flexible tilt indicator 209 may be marked directly with tilt indicia by way of a laser printing device. For example, and as shown in FIGS. 4 and 5, the tilt indicia 401 may be laser marked directly on the flexible tilt indicator 209. Tilt indicia 401 may also be imprinted on the flexible tilt indicator 209 by other printing techniques including but not limited to the use of a sprayed ink printer, transfer printing, pad printing, or any other printing method. The tilt indicia 401 may be indicative of tilt degree settings associated with the propagation direction of a beam produced by the base station antenna 100. As shown in FIGS. 4 and 5, the tilt indicia 401 may be imprinted with numerical markings indicative of the degree of tilt of the base station antenna 100, displaying even numbers (e.g., 2, 4, 6, 8, etc.). However, it may be contemplated that any numerical marking format may be implemented in still keeping with the spirit of the disclosure. For example, odd numbers may be displayed, or every third, fourth, or fifth number may be displayed with hashed marking displayed therebetween. Yet further forms of indicia may be contemplated, besides numerical, in keeping with the spirit of the disclosure, such as symbols, shapes, and other characters may be imprinted to indicate a degree of tilt of the base station antenna 100. A side view of the flexible tilt indicator 209 is shown in FIG. 6.

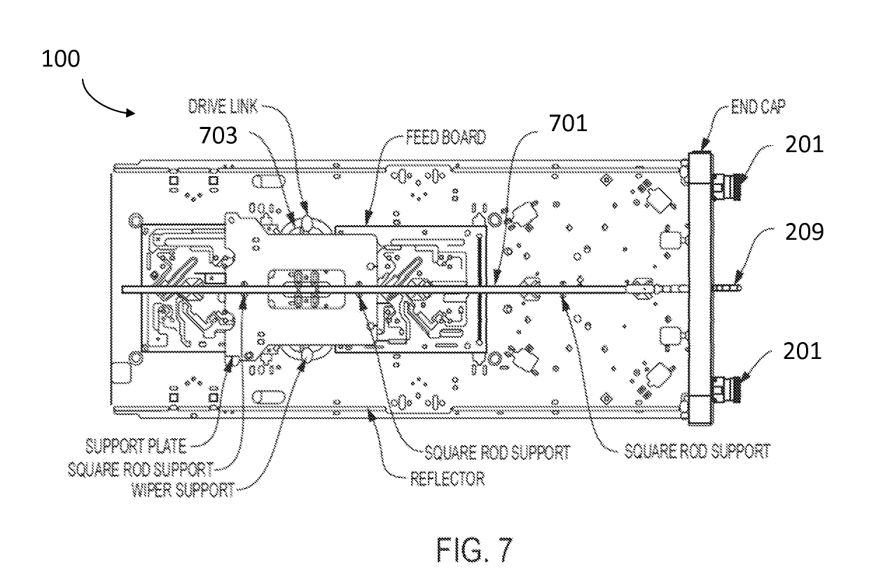

According to aspects of the present disclosure, the flexible tilt indicator 209 may also be used to adjust the tilt of the antenna 100 in addition to providing a visual indication of the tilt of the antenna 100 to which it may be attached. A view of a non-limiting example of a base station antenna 100 with the enclosure 101 removed, according to an aspect of the present disclosure, is depicted in FIG. 7. As discussed above, one end of the flexible tilt indicator 209 may be coupled to one or more phase shifters 703, for example, via a drive shaft 701 so as to move, for example, linearly, with the drive shaft 701 or connecting member. Based on such movement, a certain portion (e.g., length) of the flexible tilt indicator 209 may extend out of the bottom portion of the antenna 100 visibly indicating (via the attached indicia associated with the exposed portion of the flexible tilt indicator) a tilt angle of the antenna 100. For example, by translation of the flexible tilt indicator 209 (e.g., sliding the tilt indicator 209 up or down), phase changes in the radio frequency beam forming network inside the antenna 100 may be effected.

The material from which the flexible tilt indicator 209 may be constructed may be resilient, yet stiff enough to be used as tilt adjustment device as well. For example, such tilt indicators 209 may be constructed from a flexible material, such as thermoplastic Polyolefin Elastomer (TEO), 2800 B-75D, manufactured by RTP Co. headquartered in Winona, Minn. 55987 USA. It should be noted that the flexible tilt indicator 209 may be constructed from other material as well. For example, the flexible tilt indicator 209 may be constructed from any flexible, resilient material capable of such dual purposes (e.g., visual indication and adjustment) in keeping with the spirit of the invention.

Various embodiments of the invention have now been discussed in detail; however, the invention should not be understood as being limited to these embodiments. It should also be appreciated that various modifications, adaptations, and alternative embodiments thereof may be made within the scope and spirit of the present invention.

What is claimed is:

1. An apparatus coupled to an antenna, the apparatus comprising:
a tilt indicator including visual indicia indicative of a degree of tilt of the antenna, wherein the tilt indicator includes a flexible material.

2. The apparatus of claim 1, wherein the visual indicia are imprinted on a surface of the tilt indicator.

3. The apparatus of claim 1, wherein at least a portion of the tilt indicator is positioned external to the antenna.

4. The apparatus of claim 1, wherein the tilt indicator is coupled to a phase shifter of the antenna.

5. The apparatus of claim 4, wherein the tilt indicator moves linearly with a drive shaft connected to the phase shifter.

6. The apparatus of claim 1, wherein the tilt indicator is configured to adjust a tilt of the antenna.

7. The apparatus of claim 1, wherein the antenna is a base station antenna.

8. The apparatus of claim 1, wherein the tilt indicator is formed by injection molding.

9. An apparatus coupled to an antenna, the apparatus comprising:
a flexible tilt indicator configured to:
provide a visual indication of a degree of tilt of the antenna; and
adjust a tilt of the antenna.

10. The apparatus of claim 9, wherein the visual indicia are imprinted on a surface of the tilt indicator.

11. The apparatus of claim 9, wherein at least a portion of the tilt indicator is positioned external to the antenna

12. The apparatus of claim 9, wherein the tilt indicator is coupled to a phase shifter of the antenna.

13. The apparatus of claim 9, wherein the tilt indicator moves linearly with a drive shaft connected to the phase shifter.

14. The apparatus of claim 9, wherein the antenna is a base station antenna.

15. A method for indicating a degree of tilt of an antenna, the method comprising:
coupling a flexible tilt indicator to an antenna; and
imprinting visual indicia on the tilt indicator, the visual indicia being indicative of the degree of tilt of the antenna.

16. The method of claim 15, further comprising coupling a portion of the tilt indicator to a phase shifter of the antenna.

17. The method of claim 15, further comprising:
adjusting, using the tilt indicator, the tilt of the antenna.

18. The method of claim 15, wherein at least a portion of the tilt indicator is positioned external to the antenna.

19. The method of claim 15, wherein the antenna is a base station antenna.

20. The method of claim 15, wherein the tilt indicator is formed by injection molding.
